(19) United States
(12) Patent Application Publication
(10) Pub. No.: US 2022/0064064 A1
(43) Pub. Date: Mar. 3, 2022

(54) METHOD OF PROCESSING MOLTEN MATERIAL

(71) Applicant: RADMAT AG, Fislisbach (CH)

(72) Inventor: Alfred EDLINGER, Bartholomäberg (AT)

(21) Appl. No.: 17/415,187

(22) PCT Filed: Dec. 17, 2019
(86) PCT No.: PCT/AT2019/000034

§ 371 Date: Jun. 17, 2021

(30) Foreign Application Priority Data
Dec. 18, 2018 (AT) A 377/2018

(51) Int. Cl. C04B 5/00; C04B 7/147; B09B 3/00; C21B 3/08; C22B 7/04

(52) U.S. Cl. CPC C04B 5/00; C04B 7/147; B09B 3/005; C21B 2400/056; C21B 3/08; C22B 7/04; C21B 2400/026; B09B 3/0083

(57) ABSTRACT

In a method of processing molten material, in the form of non-metallic melt such as slag, into amorphous material, in which the molten material is vitrified by cooling, wherein the molten material for being vitrified is brought into contact with a metal bath and then discharged as amorphous material from the metal bath, the molten material is introduced into the metal bath via an open end of a dip tube immersing into the metal bath and is in the metal bath conveyed away from the area of the open end of the dip tube, preferably by means of a mechanical disintegrator, preferably a rotor.

The invention relates to a method of processing molten material in the form of non-metallic melt, such as slag, into amorphous material, in which the molten material is vitrified by cooling, wherein the molten material is brought into contact with a metal bath for being vitrified and then discharged as an amorphous material from the metal bath, as well as to a device for performing this method.

Mineral melts, such as blast furnace slags and synthetic marl slags, are usually vitrified by cooling with the aid of water in order to obtain an amorphous product which has solidified in the glass phase, i.e. a metastable phase. After a grinding process, such a product can be mixed into various cements as a latent hydraulic active component. With such a procedure, the heat of the melt is converted into low-temperature heat of water and can no longer be used.

For the purposes of the present invention, the term “non-metallic melts” includes mineral melts, blast furnace slag, steel slag, optionally mixed with SiO₂ to lower the basicity, artificial slag from marl, cement furnace bypass dust, waste incineration slag, non-ferrous metallurgical slag, smelting chamber slag from calorific power plants, cupola slags, alumina cement melts, waste glass melts, artificial pozzolan melts, industrial dust melts, such as slag melts from dried sewage sludge and the like. Furthermore, glass and ceramic melts are a suitable starting material and the process can be carried out for the production of microgranulate from glass or ceramic spheres.

Mineral melts, for example sewage sludge slag, have to be cooled extremely quickly (about 10³ K/sec) to below their recrystallization point (depending on the basicity between about 600 and 850° C.) in order to obtain a cement-compatible, amorphous and hydraulically active product. Below this recrystallization temperature, it is possible to do with a significantly lower cooling gradient.

In order to increase the slag glass content of the granulate of amorphous material or amorphous granulate and to improve the slag grindability compared to cold water granulation, boiling water granulation has been proposed in WO 01/051674 A1, in which the molten slag is introduced into cooling water at the boiling point. As a result, the latent enthalpy of evaporation of the cooling water is immediately available for faster cooling, whereby the slag glass content is maximized. The granulate surprisingly has a very low apparent density and floats on the boiling water. This means that the slag grindability is significantly improved compared to the grindability when using cold water granulation. The granulate itself is discharged from the boiling water at a temperature that exceeds the boiling temperature of the water, wherein the adhering water evaporates during the granulate discharge, so that dry granulate is directly produced. Since water is only discharged together with the granulate in vapor form, there is also no wastewater problem. The steam is condensed and returned to the granulator together with make-up water to cover the water vapor losses. The by-products formed in the slag-water reaction, such as, for example, H₂S, remain in the gas phase during the condensation of the water and are here in concentrated form, so that an economically sensible work-up is possible. On the other hand, the formation of a chemically highly polluted vapor phase requires the provision of complex installations in order to be able to treat the vapors appropriately.

A method has become known from WO 2016/145466 A1 in which the cooling water granulation has been further developed in such a way that an acid and in particular sulfuric acid is added to the cooling water for separating and/or converting contaminants, for example fluorine and chlorine compounds, alkalis, sulfur, heavy metals (e.g. Cr, V, Ni, Mo, Cu, Sn, Zn, Cd, Hg), rare earths, but also iron and free lime or unreacted CaO and MgO. The granulate obtained in this way has a particularly high reactivity and hydraulic activity and can therefore be used with great benefit in the cement industry.

The method according to WO 2016/145466 A1 is in need of improvement insofar as, on the one hand, the cooling effect of the aqueous cooling medium can be regarded as unsatisfactory due to the Leidenfrost effect and, on the other hand, the vapors produced during granulation are not only toxic but also extremely corrosive. This goes hand in hand with increased demands on exhaust air management with regard to environmentally relevant aspects and with regard to occupational safety.

For example, JP 2014065671 A discloses a method for cooling liquid slag in which the melt is charged onto a metal bath in order to vitrify it as quickly as possible on the surface of the metal bath to form a plate. A similar disclosure can be found in CN 105837041 A, where a molten glass is cooled in a tin tank to form an amorphous glass plate. All solutions of this kind are in conflict with procedural aspects in their implementation, which make them appear unsuitable.

In the patent documents DE 3220624 A1, DE 2244038 A1, WO 0014285 A1, U.S. Pat. No. 5,305,990 A and CN 105837041 A, the general prior art in the field of the invention is described.

The invention is therefore based on the object of improving a method of the type mentioned at the outset in such a way that, on the one hand, cooling takes place as quickly as possible in order to obtain a highly amorphous product for use in the cement industry without the formation of chemically contaminated vapors and, in particular, corrosive vapors, and on the other hand a stable, continuous operation of the process is made possible.

To solve this problem, a method of the type mentioned at the beginning is characterized according to the invention in that the molten material is introduced into the metal bath via an open end of a dip tube immersed in the metal bath and is removed from the area of the open end of the dip tube in the metal bath, preferably by means of a mechanical disintegrator, preferably a rotor.

Providing a metal bath for cooling the melts has the advantage over the use of aqueous cooling media that no evaporation of the cooling medium occurs at the temperatures usually prevailing when processing melts such as blast furnace slag. Compared to the use of aqueous cooling media that change into the vapor phase on the surface of the material to be cooled quickly (Leidenfrost effect), this results in a much better heat transfer from the melt to the metal as the cooling medium, so that extremely rapid cooling to below the recrystallization point of the melt takes place. The use of metal as a cooling medium is distinguished by the fact that no or no significant development of steam can be observed and the method according to the invention is therefore easy to handle and can be implemented with little expenditure on equipment. The invention also proves to be particularly advantageous insofar as there is no risk of water vapor explosions in the anhydrous vitrification and granulation process according to the invention. By the fact that the melt is introduced into the depths of the metal bath by means of a dip tube and conveyed out of, that is removed from, the area of the open end of the dip tube, i.e. from the entry area, this preferably taking place in the sense of forced conveyance and further preferably by means of a mechanical disintegrator, an extremely finely divided amorphous material is obtained as a product. In the depths of the metal bath, there are strong, sometimes turbulent flow conditions due to the conveying work that is introduced into the bath to convey the amorphously solidified melt, so that the melt is exposed to strong shear forces. This leads to a strong comminution of the introduced melt, which can be driven even further by the preferably mechanical conveyance of the amorphous material from the area of the open end of the dip tube. The melt, which cools rapidly in the metal bath, can no longer reach the area of the open end of the dip tube due to the conveying effect, as a result of which melt flowing in can be constantly introduced into the metal bath. The amorphous material formed from the melt will subsequently rise through the metal bath alongside the dip tube to the surface due to the already mentioned low density of the melt cooled in this way and thereby granulated to form amorphous material and accumulate there. As the melt continues to flow in, the amorphous material will continue to accumulate on the surface and be layered by the amorphous material rising from the metal bath and can finally be discharged.

To apply shear forces to the molten material introduced into the metal bath, it is preferably provided that the molten material is at least partially conveyed out of the area of the open end of the dip tube by means of a gas flow introduced into the metal bath via a lance.

The molten material is preferably disaggregated by the combined action of the gas stream introduced and the mechanical conveyance or disintegration of the molten material, the mechanical conveyance, as mentioned, preferably taking place by a mechanical disintegrator.

According to a preferred embodiment of the present invention, the method according to the invention is further developed in that the molten material is conveyed from the area of the open end of the dip tube at least partially by moans of a gas flow from a lance guided inside the dip tube and immersed in the metal bath, wherein guide vanes for directing a flow are preferably arranged in the metal bath in the region of the mouth of the lance. A gas stream of inert gases such as nitrogen, CO₂ or Ar and/or of reactive gases such as H₂, NH₃ or CO can be ejected from the lance into the area of the open end and into the top layer of the metal bath and through the guide vanes to convey the molten material into the metal bath through the resulting suction and at the same time to expose it to high shear forces for comminution. The amorphous material or granulate that is formed is conveyed out of the area of the open end of the dip tube by the resulting flow.

According to a further preferred embodiment of the present invention, the method according to the invention is developed in such a way that the molten material is removed from the area of the open end of the dip tube at least partially by means of a gas flow that comes from a lance directed from the metal bath to the open end of the dip tube immersed in the metal bath, wherein guide vanes for directing a flow are preferably arranged in the metal bath in the region of the mouth of the lance. A gas stream of inert gases such as nitrogen, CO₂ or Ar and/or of reactive gases such as H₂, NH₃ or CO can be ejected from the lance through the guide vanes into the area of the open end and into the top layer of the metal bath, to convey the molten material into the metal bath through the resulting suction and at the same time to expose it to high shear forces for comminution. The amorphous material or granulate that is formed is conveyed out of the area of the open end of the dip tube by the resulting flow.

According to a preferred embodiment of the present invention, it is provided that the molten material is charged onto a reactive metal bath, preferably a reactive tin bath, that is arranged upstream of the metal bath, wherein the reactive metal bath is prepared to adjust the basicity (CaO/SiO₂) of the molten material to a target basicity of 0.85 to 1.6, preferably 1.3 to 1.6, by adding reactive components selected from the group consisting of lime carriers and SiO₂ carriers. The adaptation of the basicity, the ratio of CaO to SiO₂, in the molten material, such as the educt slag melt, is of great importance for the viscosity and thus for the disintegration behavior of the molten material in the metal bath intended for cooling or vitrification, since for example at basicities of around 1.9, the slag melt becomes highly viscous and can practically no longer be granulated in the metal bath. In the case of slag melts, the initial basicities are sometimes in the range of 3, so that acidification of the molten material with SiO₂ carriers is necessary. Depending on the type of molten material and its basicity, however, the basicity can also be increased by adding CaO carriers, i.e. lime carriers. With the preferred setting of the basicity to values of 1.3 to 1.6, belite grains precipitate in the slag melt, which, after the step of cooling by vitrification, significantly improves the suitability of the end product for the cement industry due to its high hydraulic activity. When processing highly problematic waste fiber mats and materials, the reactive metal bath can serve as a premelting unit. The optionally heated reactive metal bath can, in addition to setting the basicity of the molten material, also be very significant for setting the temperature and thus the viscosity of the molten material.

The present invention can furthermore advantageously be developed in that the reactive metal bath is prepared by adding Al₂O₃ carriers to set an Al₂O₃ content in the molten material of 4% by weight to 18% by weight.

According to a preferred embodiment of the present invention, the molten material is forced into the metal bath by the action of a mechanical disintegrator. This means that the mechanical disintegrator, which, as already mentioned, can preferably be designed as a rotor, is preferably designed in such a way that a type of vortex arises during operation of the disintegrator, which is directed in the direction of the depth of the metal bath and which presses the melt or molten slag, which hits the metal bath at the open end of the dip tube, into the metal bath. In this way, very high shear forces are applied to the melt to be cooled, which leads to an extremely effective comminution of the melt. This promotes rapid cooling, which in turn promotes the formation of an almost entirely amorphous structure and low density of the product. With the method according to the invention, a spherical granulate can thus be obtained in an advantageous manner that, due to its finely divided size distribution, can be used in the cement industry without the need for a grinding step. The formation of spherical granules is explained by the large difference in viscosity and surface tension between the molten material introduced and the metal bath, in particular the tin bath melt. In the case of slag melt, the molten material introduced has a comparatively low surface tension and a high viscosity compared to the relatively high surface tension and the low viscosity of the metal bath, in particular of the tin melt. From a preferred ratio of slag:metal bath, in particular slag:tin, of 1:3.4, the metal bath envelops the slag melt and a dispersion of slag droplets is formed in the metal bath, but the metal bath is not coated by the slag melt. Due to the applied shear forces, the slag melt is further dispersed in the metal bath and the slag melt is shaped into a microspherical shape due to the different surface tensions. The rule here is that the higher the temperature of the metal bath and the more significant the shear forces that are introduced, the smaller the diameter of the slag spheres.

A number of metals are suitable for use as a cooling medium for the melt, metals with a low melting point and a high boiling point generally being favorable for use in the context of the present invention. A low melting point makes it possible to provide a metal bath that is very cool compared to the introduced melts, and a high boiling point prevents evaporation losses from the metal bath and the associated development of vapors that are harmful to health and the environment. From this aspect, the method according to the present invention is preferably developed in such a way that the metal bath is formed from tin, preferably alloyed to 3% by weight with silver and 1% by weight with copper. Tin has a melting point of 231.93° C. and the boiling point is 2620° C., which is why a wide temperature range can be used for cooling slag, for example, without, the risk of the metal evaporating. The non-metallic melts that are processed into amorphous granules in the context of the present invention are preferably introduced at about 1350° C. to 1850° C., so that a temperature difference of about 1200° C. is available for rapid cooling of the melt to amorphous material. If the tin bath is also alloyed with silver and copper, the melting point can even be lowered to 219° C. and the oxidation activity of the metal bath is reduced.

According to a preferred embodiment of the present invention, the method is further developed in that the metal bath is kept at a temperature below the recrystallization temperature of the molten material, in particular at a temperature of between 300° C. and 600° C., in which temperature range, even in case of an irregular introduction of molten material, there is no need to fear solidification of the metal bath, nor must a temperature of the tin as a cooling medium be accepted that would be disadvantageously high for sufficient rapid cooling.

Under certain circumstances, the temperature of the metal bath can only be maintained by the heat of the molten material introduced. However, in order to adapt the suitability of the method according to the invention for processing large quantities of melts, the heat introduced into the metal bath by the molten material can be removed by means of a coolant flowing through a heat exchanger, as corresponds to a preferred embodiment of the present invention. So if large amounts of melt or slag and the associated large amounts of heat are introduced into the metal bath and the temperature of the metal bath therefore rises to such an extent that the melt cannot be cooled sufficiently quickly for vitrification or granulation of the material, this allows coolant in the heat exchanger to dissipate the heat introduced with the melt and thus to keep the metal bath at the desired temperatures.

The coolant is preferably selected from the group consisting of liquid oxygen, air, inert gas, thermal oil, water and ionic liquids, in particular aqueous solutions of sodium, magnesium and calcium chloride and potassium carbonate. These coolants are suitable for the temperature ranges relevant in the context of the present invention and can be circulated and thermally controlled with systems known in the prior art. In the case of liquid oxygen as the coolant, the process can be used to good effect to replace expensive oxygen evaporation systems. The oxygen heated in this way can preferably be used to drive an oxygen gas turbine to generate energy, the oxygen gas preferably being expanded to a pressure level that is necessary for burning the remaining hot oxygen in an oxifuel burner.

In this context, it is particularly advantageous if the heat of the coolant is recovered as mechanical and/or electrical energy, in particular in a gas turbine or a pressurized water heat exchanger with combined heat and power. In contrast to the prior art described above, the method according to the invention allows the heat of the molten material, for example the molten sewage sludge slag introduced into the metal bath, to be extracted with the cooling medium and subsequently made usable. The recovery of the heat allows the entire mechanical operation of the process according to the invention. Experiments have shown that the mechanical energy requirement is around 15-35 kWh/t of granulate (of the amorphous material), which can easily be obtained from the recovered enthalpy of the molten material introduced. The amounts of heat that are contained in blast furnace or sewage sludge slag, for example, are significant and are particularly high in exergy, so that they can be used in a variety of processes.

For example, the heat of the coolant can be used to promote endothermic chemical reactions, as corresponds to another preferred embodiment of the present invention. The heat of the coolant is particularly preferably used here for the depolymerization of waste plastic fractions, in particular of polyethylene, polypropylene and polyethylene terephthalate. In this case, mono- and oligomers, in particular unsaturated oligomers, which can subsequently be used in synthetic chemistry for the production of new plastics, arise from the polymers and in particular from the polymers of the thermoplastics mentioned. The method according to the invention can therefore be usefully combined with disposal processes that differ from those of the steel industry or the cement industry, for example in waste disposal. The same endothermic reactions can also be promoted in such a way that the substances mentioned, such as waste plastic fractions, in particular polyethylene, polypropylene and polyethylene terephthalate, are introduced directly into the metal bath, whereby the metal bath is also effectively cooled. For this purpose, it can preferably be provided that the tin bath, by alloying with Ag, Cu, Ft, Co, Ni, Ru, Rh and/or Pd, is provided with special catalytic properties to control/optimize the mentioned endothermic reactions such as depolymerization/cracking, hydrogenation, carbonylation. By adding NH₃ to the tin bath, waste carbon fibers can be converted into valuable chemical intermediates such as acrylonitrile. This type of chemical cooling can take place alternatively or in addition to the aforementioned physical cooling by means of a heat exchanger with a coolant.

For discharging the amorphous material, the method can preferably be developed in such a way that the amorphous material is discharged with the aid of a conveying means selected from the group consisting of a conveyor belt and a conveyor wheel. With the conveyor wheel, the material is conveyed from the surface of the metal bath over an edge or from a discharge region of the granulating tundish in which the metal bath is held and then usually falls into a container or pipeline not described in detail here and can be further processed or deposited.

According to a preferred embodiment of the present invention, the metal bath is flushed with an inert gas, in particular nitrogen. On the one hand, this results in an extension of the service life of the metal bath, because the inert gas displaces the atmospheric oxygen from the surface of the metal bath, and, on the other hand, this results in a loosening of the amorphous material floating on the surface of the metal bath, so that possibly on particles of the tin adhering to amorphous material can run off better. In general, special filtration of the amorphous material during or after removal from the metal bath can thus be dispensed with.

According to a preferred embodiment of the present invention, the method is further developed to the effect that the amorphous material, after having been discharged, is sprayed with at least one liquid selected from the group consisting of water, an aqueous sulfuric acid solution, an aqueous lignin sulfonate solution and sulfonated aromatics, in particular aniline, pyridine, naphthalene, anthracene, phenol and/or cresol derivatives, in particular up to a temperature of the vitrified material of between 120° C. and 250° C., resulting in sulfation reactions known from the prior art and, as mentioned above, impurities can be removed or converted. The slag products that are formed significantly improve slag cement processing in particular through a massive reduction in the mortar water requirement. This leads to an increase in the early strength as well as the frost resistance and dew resistance of the mortar and types of concrete made from it. Mixtures of dilute sulfuric acid and sulfonated aromatics can of course also be used and thus an optimal adaptation to the respective mortar and concrete application is achieved. Such cements also have an increased resistance to chemicals and, in particular, to sulphate.

In this variant of the present invention, the vapors formed during spraying are preferably condensed and recovered in order to prevent the vapors from escaping into the working environment and/or the atmosphere and at the same time to make the process more economical.

Due to the nature of the surface of the amorphous material produced in the course of the process according to the invention, there is no tendency for the metal from the metal bath to adhere to the granulated melt. However, should this happen in individual cases due to the shape of the granulate, the method according to the invention can advantageously be further developed to the effect that the amorphous material is filtered and/or centrifuged to remove entrained metal.

The device according to the invention for carrying out the method according to the invention comprises a granulating tundish with a preferably ring-shaped or rectangular cross-section for receiving a metal bath, a dip tube having an open end in the granulating area of the granulating tundish provided for the metal bath, and a discharge region for the amorphous material, and is characterized in that a mechanical disintegrator, preferably a rotor, is arranged in the area of the open end of the dip tube.

According to a preferred embodiment of the present invention, a lance dipping into the metal bath is guided in the interior of the dip tube for ejecting a gas flow and guide vanes for directing a flow are preferably arranged in the metal bath in the region of the mouth of the lance. A gas stream of inert gases such as nitrogen or CO₂ or of reactive gases such as NH₃, H₂ or CO can be ejected from the lance into the area of the open end and into the top layer of the metal bath as well as through the guide vanes in order to convey the molten material into the metal bath through the resulting suction and at the same time to expose it to high shear forces for comminution. The amorphous material or granulate that is formed is conveyed out of the area of the open end of the dip tube by the resulting flow.

According to a further preferred embodiment of the present invention, a lance is directed from the metal bath to the open end of the dip tube immersed in the metal bath for ejecting a gas flow and guide vanes for directing a flow are preferably arranged in the metal bath in the region of the mouth of the lance. A gas stream of inert gases such as nitrogen or CO₂ or of reactive gases such as H₂, NH₃ or CO can be ejected from the lance through the guide vanes into the area of the open end and into the top layer of the metal bath, in order to convey the molten material into the metal bath through the resulting suction and at the same time to expose it to high shear forces for comminution. The amorphous material or granulate that is formed is conveyed out of the area of the open end of the dip tube by the resulting flow.

For the introduction of the melt, it can be provided according to a preferred embodiment of the present invention that the dip tube is connected to a discharge opening of a storage tundish which receives the molten material and a weir tube for forming an optionally interrupted annular space is immersed in the molten material. The formation of an annular space along the circumference of a weir tube in a storage tundish for the molten material leads to the fact that when slag melt or a similar melt enters the dip tube through the annular space, a pre-disaggregation of the melt in the dip tube is achieved, so that the melt enters the metal bath as a relative thin film and can therefore be disintegrated particularly easily. The weir tube can be designed to form an annular space with an adjustable height, as corresponds to a preferred development of the present invention, which makes it possible in a simple manner to regulate the flow of the melt through the annular space into the dip tube and to adapt it to the respective requirements of the process.

Preferably, a reactive metal bath, preferably reactive tin bath, is kept in the storage tundish, wherein the reactive metal bath comprises reactive components selected from the group consisting of lime carriers and SiO₂ carriers for adjusting the basicity (CaO/SiO₂) of the molten material to a target basicity of 0.85 to 1.6, preferably 1.3 to 1.6. The advantages associated with this have already been explained in connection with the method according to the invention.

Furthermore, the reactive metal bath preferably contains Al₂O₃ carriers for setting an Al₂O₃ content in the molten material of 4% by weight to 18% by weight. The advantages associated with this have already been explained in connection with the method according to the invention.

In order to ensure particularly thorough disintegration of the melt when it is introduced into the metal bath, the device according to the invention is preferably developed in such a way that the mechanical disintegrator is formed by a plurality of actuators that can be driven to rotation and by stators emerging from the wall of the granulating tundish. When the actuators are driven to rotate, they move just past the stators, so that high shear forces occur in the metal bath in the areas between the actuators and the stators, which lead to a finely divided division of the introduced melt. This in turn leads to particularly rapid cooling of the melt in the metal bath and thus to a highly amorphous material as the end product.

According to a preferred embodiment of the present invention, it is provided that the stators and/or the actuators are designed to emit inert gas, preferably nitrogen, into the metal bath. On the one hand, this results in the inert gas displacing the atmospheric oxygen from the surface of the metal bath and thereby in an extension of the service life of the metal bath, and, on the other hand, this results in a loosening of the amorphous material floating on the surface of the metal bath, so that tin possibly adhering to particles of the amorphous material can run off better. In addition, the inert gas can contribute to a certain extent to cooling the metal bath. According to a further preferred embodiment, the stators and/or actuators are designed for the passage of a coolant.

According to a preferred embodiment of the present invention, the gas space of the granulating tundish is connected to a line for inert gas, so that the gas space of the granulating tundish can also be selectively flushed with inert gas, preferably nitrogen, if necessary, in order to extend the service life of the metal bath.

The amounts of heat introduced via the melt during continuous and industrial operation of the method according to the invention and the device according to the invention can be dissipated, according to a preferred embodiment, by arranging a heat exchanger as a cooling body in or on the wall of the granulating tundish. The wall of the granulating tundish referred to here can either be the bottom and/or at least one side wall of the granulating tundish. As an alternative or in addition, the device according to the invention can also be developed in such a way that a heat exchanger is arranged as a cooling body in the granulating tundish in the volume for the metal bath. In this case, the heat exchanger is immersed directly in the metal bath, which on the one hand results in an improved heat transfer from the metal bath to the cooling medium, but on the other hand exposes the heat exchanger to greater wear, so that the two mentioned variants of the arrangement of the heat exchanger are selected or can also be combined with each other depending on the area of application. The increased metal bath or tin bath volume leads to a heat buffer so that the granulation is very flexible with regard to the slag inflow. With strongly fluctuating slag inflow, one can work with several dip tubes and thus in the optimal slag distribution area.

In a particularly preferred manner, a discharge device in the form of a conveyor wheel is arranged in the discharge region. With the conveyor wheel, the material is conveyed from the surface of the metal bath over an edge or a discharge opening of a granulating tundish in which the metal bath is held and then usually falls into a container or pipeline not described in detail here and can be further processed or deposited. The conveyor wheel can also be designed as a hollow roller with a perforated surface, on which any tin still adhering to the granulate can drain from the metal bath, as corresponds to a preferred embodiment of the present invention. The separation of adhering tin from the granulate can preferably be assisted by a stream of nitrogen which is directed from an appropriate register onto the perforated surface of the hollow roller. In addition, the granulate can be blown off the surface of the hollow roller from the inside of the hollow roller by means of a stream of air or nitrogen at a discharge end of the hollow roller.

Alternatively, according to a preferred embodiment of the present invention, a discharge device in the form of a plurality of conveyor belts, for example made of steel belt, guided over deflection rollers and arranged downstream of one another, can be arranged in the discharge region, wherein the conveyor belts are conducted out of the metal bath in an ascending way, preferably at an angle of 30° to 50°, particularly preferably 40°, relative to the surface of the metal bath, wherein in each case a discharge for the amorphous material and/or for metal carried along from the metal bath is formed at an upper pulley and wherein in each case a discharge of a conveyor belt is arranged above a downstream conveyor belt for forming a cascade of conveyor belts. Such a cascade of conveyor belts is an extremely effective device for separating metal, in particular tin, carried along from the metal bath, an angle of inclination of 30°-50°, in particular approximately 40°, with respect to the metal bath surface having proven to be particularly effective in tests. The first conveyor belt thus lifts amorphous material with metal adhering to it from the metal bath and throws the amorphous material at the discharge onto the next ascending conveyor belt, with adhering metal successively running off the amorphous material. In this way, all of the metal is gradually separated from the amorphous material. Alternatively, according to a preferred embodiment of the present invention, it is also conceivable that an inclined vibrating channel cascade immersed in the metal bath is provided in order to separate off the excess metal.

To support the separation of the metal from the amorphous material, the invention can preferably be developed in such a way that a further roller is held, preferably resiliently held, against the conveyor belt, in the area of the upper pulley. This further roller, which can also be referred to as a squeezing roller, exerts a preferably adjustable pressure on the amorphous material and thus squeezes adhering metal out of the mass of the amorphous material. The further rollers or squeezing rollers are preferably kept isothermal.

Finally, at the end of the cascade of conveyor belts, the dropping of the last of the conveyor belts arranged downstream can foe arranged above an insertion opening of a cooling device for the amorphous material, the cooling device preferably being flowed through by a coolant, preferably in countercurrent, as is the case with a preferred embodiment of the present invention. A number of different coolants are also conceivable here, the cooling preferably being carried out up to a temperature of approximately 150° C. The cooling device for the amorphous material is preferably designed in the form of a horizontally running screw conveyor which is surrounded by a double-walled housing for introducing coolant into the housing wall.

The invention is explained in more detail below with reference to an exemplary embodiment shown in the drawing. In the drawings

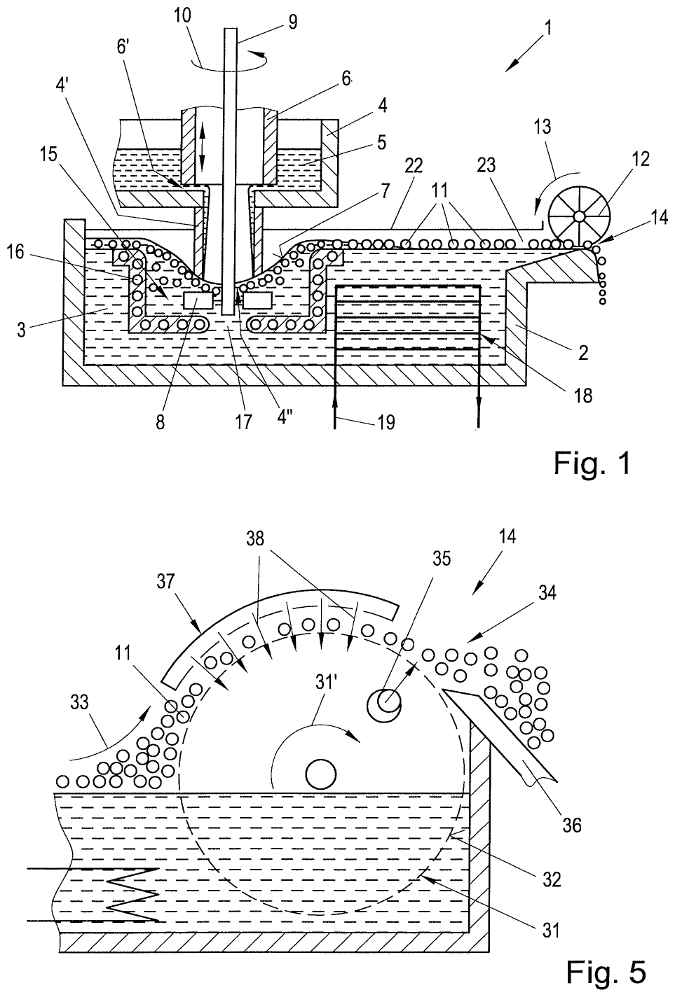

FIG. 1 is a schematic representation of a device according to the invention with a dip tube and a mechanical disintegrator for conveying and disintegrating the melt and a heat exchanger in the volume for the metal bath in the granulating tundish.

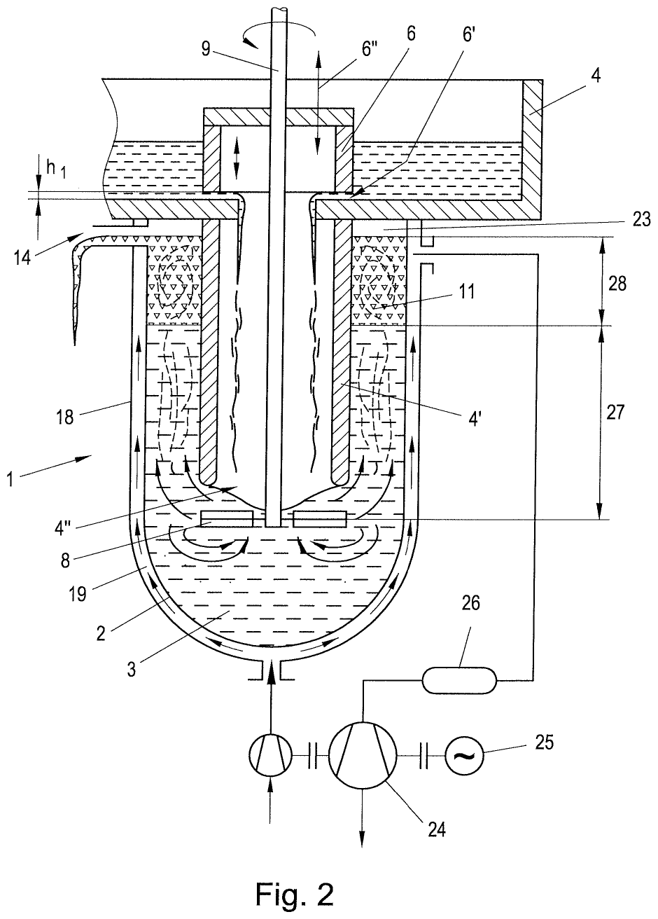

FIG. 2 shows a variant according to the invention of a device according to the invention with a mechanical disintegrator in the form of a rotor,

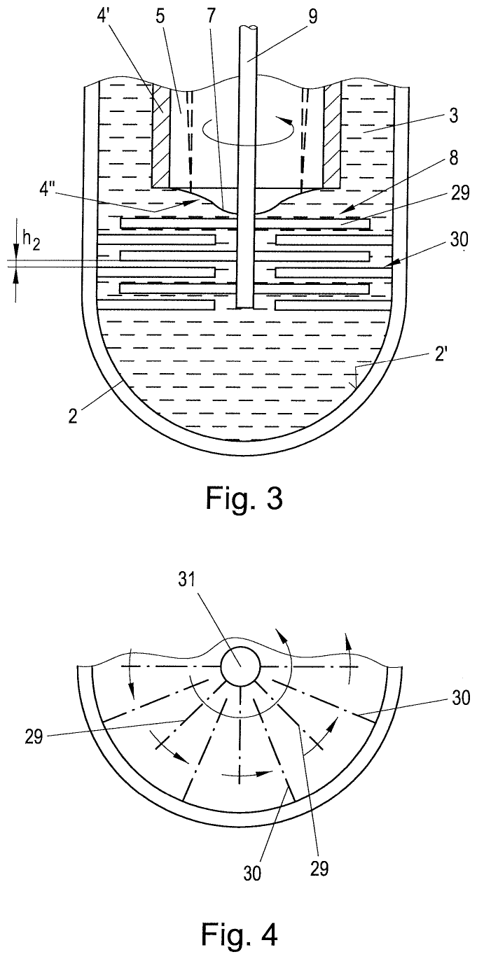

FIG. 3 shows a preferred design of a rotor,

FIG. 4 shows a partial plan view of the mechanical disintegrator according to FIG. 3,

FIG. 5 shows an illustration of a discharge device according to the invention in the form of a hollow roller,

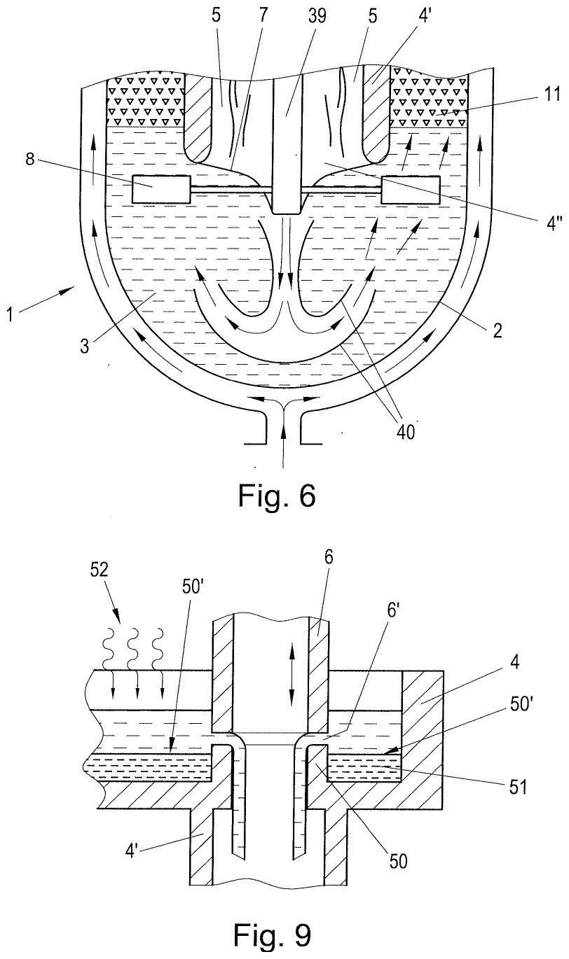

FIG. 6 shows a variant according to the invention of a device according to the invention with a disintegrator in the form of a lance guided inside the dip tube and immersed in the metal bath,

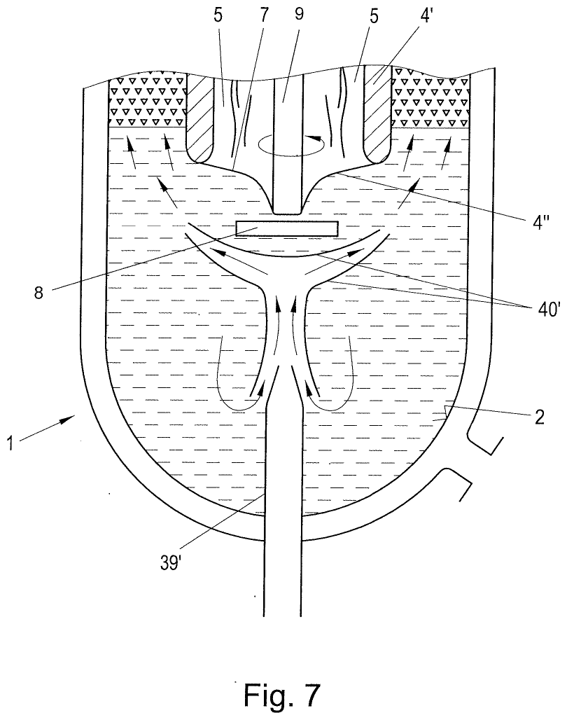

FIG. 7 shows a variant according to the invention of a device according to the invention with a disintegrator in the form of a lance directed from the metal bath to the open end of the dip tube immersed in the metal bath,

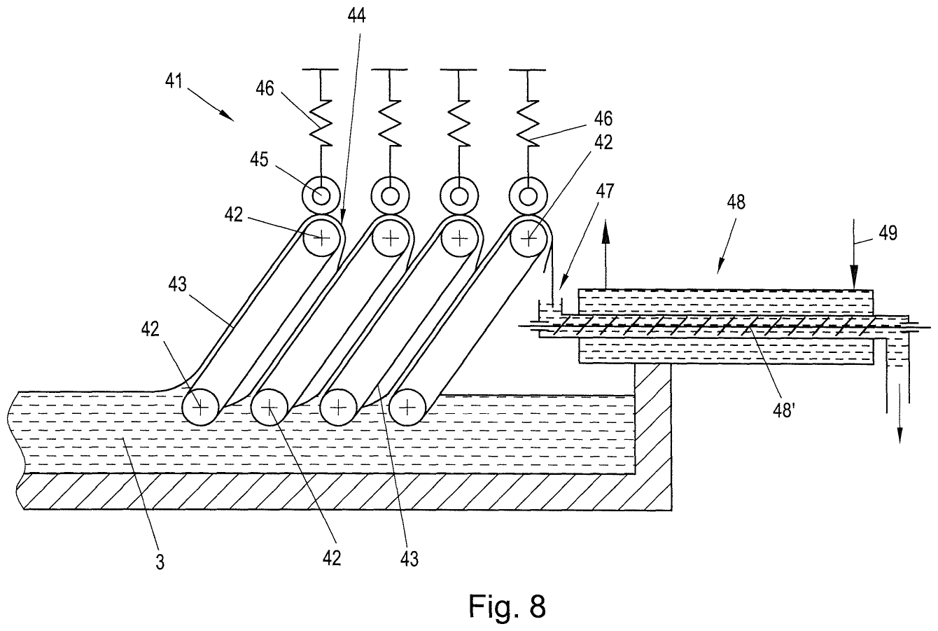

FIG. 8 shows a discharge device and

FIG. 9 shows a preferred variant of a design of a storage tundish.

A device or granulating device 1 according to the invention for use in carrying out the method according to the invention comprises, according to FIG. 1, a granulating tundish 2 in which a metal bath 3 made of liquid tin is held. From a storage tundish 4, in which the molten material 5 to be vitrified or the melt 5 is located, the molten material 5 is dosed by means of a weir tube 6, which together with the storage tundish 4 forms an annular space 6′, via the open end 4″ of the dip tube 4′ into the underlying granulating tundish 2 with the metal bath 3. The melt 5 hits the surface 7 of the metal bath 3 as an essentially hollow cylindrical jacket and in the metal bath 3 it is subjected to large shear forces by the action of the mechanical disintegrator 8, in this case the rotor 8, which is driven by the shaft 9 to rotate in the direction of the arrow 10. This leads to a disintegration of the melt 5 in the metal bath, which is cooled in finely divided form in the metal bath 3 and instantaneously solidifies in the glass-like, amorphous state and is thus granulated. The granulate 11 or the amorphous material 11 is discharged with the aid of the conveyor wheel 12, which is driven to rotate in the direction of the arrow 13, in the discharge region 14 of the granulating tundish 2 and ejected into a container (not shown). In the area of the mechanical disintegrator 8 or rotor 8, the granulating tundish 2 has a mixing chamber 15 which is kept as constant as possible at a temperature of 300° C., for example, by a heat exchanger 16. The melt 5 flows into the mixing chamber 15 and is mixed into the metal bath 3 there. The base of the mixing chamber has an opening 17 through which molten tin is sucked in from the metal bath 3 by the action of the rotor 8, which leads to an increase in the turbulence in the area of the rotor 8 in order to optimize the disintegration of the melt 5.

Reference numeral 18 denotes a heat exchanger in the volume for the metal bath 3 in the granulating tundish 2, in which a coolant 19 flows and via which the majority of the heat introduced by the melt 5 is transported away from the metal bath 3 or from the granulating device 1 and is recycled. The gas space 23 of the granulating tundish 2 is covered by a cover 22.

In FIG. 2, the same features are provided with the same reference signs. In particular, a granulating tundish 2 with a metal bath 3 made of tin is again shown. Via the annular space 6′, the height h₁ of which can be adjusted by raising and lowering the weir tube 6 in the direction of the double arrow 6″, the melt 5 can be introduced into the metal bath 3 via the open end 4″ of the dip tube 4′ and can be disintegrated by means of the rotor 8. The melt 5 is cooled in finely divided form in the metal bath 3 and immediately solidifies in the glass-like, amorphous state and is thus granulated. The granulate 11 is discharged in the discharge region 14 and ejected into a container (not shown). Here, too, the metal bath 3 is kept at a temperature of approximately 300° C., which temperature is maintained by means of the heat exchanger 18. The granulating tundish 2 is covered by the storage tundish 4 and the gas space 23 above the metal bath 3 can preferably be flushed with an inert gas, in particular with nitrogen, to protect and thus extend the service life of the metal bath 3.

In the example shown in FIG. 2, the heat exchanger 18 conveys air as coolant 19, the heat of the coolant being recovered as electrical energy via a combined heat and power system in the form of a gas turbine 24, which is coupled to a generator 25. A fuel can preferably be added to the hot exhaust air or the coolant in a combustion chamber 26, in order to, e.g., usefully dispose of inferior fuels in the form of dusts, gases or liquids such as tar, which for example occur in small amounts in the production of the molten material from sewage sludge. In FIG. 2, the height of the metal bath 3 is to be understood as a granulating zone 27, followed by a filtering zone 28 in the gas space 23, in the area of the amorphous material 11 or granulate 11, in which any tin can drip off.

In FIGS. 3 and 4, the mechanical disintegrator 8 is formed by a plurality of actuators 29 that can be driven to rotate by means of a shaft 9 and stators 30 emerging from the wall 2′ of the granulating tundish 2. The actuators 29 and/or the stators 30 can be designed to emit inert gas into the metal bath 3. As can be seen from FIG. 3, there is only a relatively small distance h₂ between the actuators 29 and the stators 30, as a result of which the melt 5 introduced into the metal bath 3 via the open end 4″ of the dip tube 4′ is exposed to high shear forces for disintegration when the stators 30 are swept over by the actuators 29, as is shown schematically in FIG. 4.

In FIG. 5, instead of a conveyor wheel, a hollow roller 31 which can be driven to rotate in the direction of arrow 31′ is arranged in the discharge region 14, which has a perforated surface 32 to allow any tin adhering to the granulate 11 to run off after it has been picked up by the hollow roller 31 in the direction of the arrow 33 and while the granulate 11 is conveyed to a discharge end 34 of the hollow roller 31 in order to be blown off the surface 32 by a fan 35 there. In addition to this, a scraper 36 can also be provided in order to scrape granules 11 from the surface 32 of the hollow roller 31. Reference numeral 37 denotes a register from which a gas stream in the sense of arrows 38, in particular of air or an inert gas kept isothermally with the tin bath temperature, optionally mixed with reducing gas (H₂, CO, NH₃), in particular nitrogen, is directed onto the perforated surface 32 of the hollow roller 31 for separating adhering tin from the granulate 11.

In FIG. 6, the same features are denoted by the same reference numerals as in FIG. 2 and it can be seen that a lance 39 guided inside the dip tube 4′ and immersed in the metal bath 3 is provided. A gas stream of inert gases such as nitrogen or CO₂ and/or of reactive gases such as H₂ or CO or NH₃ can be ejected from the lance 39 into the area of the open end 4″ and into the top layer of the metal bath 3 in order to convey the molten material 5 into the metal bath 3 by means of the resulting suction and at the same time to subject it to high shear forces for comminution. The amorphous material 11 or granulate 11 formed is conveyed out of the area of the open end 4″ of the dip tube 4′ by the resulting flow. Reference numeral 40 designates guide vanes for directing a flow. The lance 39 can be rotatably mounted and used as a shaft for an optional disintegrator 8.

Furthermore, a lance 39′ directed from the metal bath 3 to the open end 4″ of the dip tube immersed in the metal bath 3 is shown in FIG. 7. In the area of the mouth of the lance 39, guide vanes 40″ are arranged for directing a flow. A gas stream of inert gases such as nitrogen or CO₂ and/or of reactive gases such as H₂, CO or NH₃ can be ejected from the lance 39 through the guide vanes 40′ into the area of the open end 4″ and into the top layer of the metal bath 3, in order to convey the molten material 5 into the metal bath 3 by the resulting suction and at the same time to subject it to high shear forces for comminution. The amorphous material 11 or granulate 11 formed is conveyed out of the area of the open end 4″ of the dip tube 4′ by the resulting flow.

In FIG. 8 a discharge device 41 is shown in the form of a plurality of conveyor belts 43 made of steel belt, guided over pulleys 42 and arranged downstream of one another, wherein the conveyor belts 43 are conducted out of the metal bath 3 in an ascending way, preferably at an angle of about 30° to 50° relative to the surface of the metal bath 3, wherein in each case a discharge 44 for the amorphous material 11 and for metal carried along from the metal bath 3 is formed at an upper pulley 42 and wherein in each case a discharge 44 of a conveyor belt 43 is arranged above a downstream conveyor belt 43 for forming a cascade of conveyor belts 43. In each case in the area of the upper pulley 42, a further roller 45 is held against the conveyor belt 43 by means of a spring 46. These further rollers 45, which can also be referred to as squeezing rollers, exert an adjustable pressure on the amorphous material 11 and thus squeeze adhering molten metal from the mass of the amorphous material 11. The discharge 44 of the last of the conveyor belts 43 arranged downstream of one another is arranged above an insertion opening 47 of a cooling device 48 for the amorphous material, the cooling device 48 preferably being flowed through by a coolant 49, preferably in countercurrent. The coolant 49 can in turn be used to cool the granulating tundish 2 and for this purpose it can be fed to the wall of the granulating tundish 2, as shown in FIG. 2. The cooling device 48 has a screw conveyor 48′ for conveying the granulate 11.

In the illustration according to FIG. 9 it can be seen that the provision of an annular weir 50 or weir stone 50 creates a volume 50′ for holding a reactive metal bath 51, wherein the annular space 6′ in this case is formed between the weir 50 and the weir tube 6. The arrows 52 symbolize that the storage tundish 4 can be heated if this should be necessary.

1. A method of processing molten material (5), in the form of non-metallic melt (5) such as slag, into amorphous material (11), in which the molten material (5) is vitrified by cooling, wherein the molten material (5) for being vitrified is brought into contact with a metal bath (3) and then discharged as amorphous material (11) from the metal bath (3), characterized in that the molten material (5) is introduced into the metal bath (3) via an open end (4″) of a dip tube (4′) immersing into the metal bath (3) and in the metal bath (3) is conveyed away from the area of the open end (4″) of the dip tube (4′), preferably by means of a mechanical disintegrator (8), preferably rotor (8).

2. The method according to claim 1, characterized in that the molten material (5) is conveyed from the area of the open end (4″) of the dip tube (4′) at least partially by means of a gas flow introduced into the metal bath (3) via a lance (39), wherein guide vanes (40) for directing a flow are preferably arranged in the metal bath (3) in the region of the mouth of the lance (39).

3. The method according to claim 2, characterized in that the lance (39) is guided inside the dip tube (4′) and dips into the metal bath (3) from above, or the lance (39′) is directed from the metal bath (3) towards the open end (4″) of the dip tube (4′).

4. The method according to claim 1, 2 or 3, characterized in that the molten material (5) is charged onto a reactive metal bath (51), preferably a reactive tin bath (51), that is arranged upstream of the metal bath (3), wherein the reactive metal bath (51) is prepared to adjust the basicity (CaO/SiO₂) of the molten material to a target basicity of 0.85 to 1.6, preferably 1.3 to 1.6, by adding reactive components selected from the group consisting of lime carriers and SiO₂ carriers.

5. The method according to claim 4, characterized in that the reactive metal bath is prepared by adding Al₂O₃ carriers to set an Al₂O₃ content in the molten material of 4 wt.-% to 18 wt.-%.

6. The method according to any one of claims 1 to 5, characterized in that the molten material (5) is sucked or pressed into the metal bath (3) by the action of a mechanical disintegrator (8).

7. The method according to any one of claims 1 to 6, characterized in that the metal bath (3) is formed from tin, preferably alloyed to 3% by weight with silver and 1% by weight with copper.

8. The method according to any one of claims 1 to 7, characterized in that the metal bath (3) is kept at a temperature below the recrystallization temperature of the molten material, in particular at a temperature of between 300° C. and 600° C.

9. The method according to any one of claims 1 to 8, characterized in that the heat introduced into the metal bath (3) by the molten material (5) is dissipated by means of a coolant (19) flowing through a heat exchanger (18).

10. The method according to claim 9, characterized in that the coolant (19) is selected from the group consisting of liquid oxygen, air, inert gas, thermal oil, water and ionic liquids, in particular aqueous solutions of sodium, magnesium and calcium chloride and potassium carbonate.

11. The method according to claim 9 or 10, characterized in that the heat of the coolant (19) is recovered as mechanical and/or electrical energy, in particular in a gas turbine (24) or a pressurized water heat exchanger with combined heat and power.

12. The method according to claim 9, 10 or 11, characterized in that the heat of the coolant (19) is used to promote chemical reactions.

13. The method according to any one of claims 9 to 12, characterized in that the heat of the coolant (19) is used for the depolymerization of plastics, in particular of polyethylene, polypropylene and polyethylene terephthalate.

14. The method according to any one of claims 1 to 13, characterized in that the amorphous material (11) is discharged with the aid of a conveying means selected from the group consisting of a conveyor belt and a conveyor wheel (12).

15. The method according to any one of claims 1 to 14, characterized in that the metal bath (3) is flushed with an inert gas, in particular nitrogen.

16. The method according to any one of claims 1 to 15, characterized in that the amorphous material (11), after having been discharged, is sprayed with at least one liquid selected from the group consisting of water, an aqueous sulfuric acid solution, an aqueous lignin sulfonate solution and sulfonated aromatics, in particular aniline, pyridine, naphthalene, anthracene, phenol and/or cresol derivatives, in particular up to a temperature of the vitrified material of between 120° C. and 250° C.

17. The method according to claim 16, characterized in that the vapors formed during spraying are condensed and recovered.

18. The method according to any one of claims 1 to 17, characterized in that the amorphous material (11) is filtered and/or centrifuged to remove metal entrained from the metal bath.

19. A device for carrying out the method according to any one of claims 1 to 18, comprising a granulating tundish (2) with a preferably annular or rectangular cross-section for receiving a metal bath (3), a dip tube (4′) having an open end (4″) in the granulating area (27) of the granulating tundish (2) provided for the metal bath (3), and a discharge region (14) for the amorphous material (11), characterized in that a mechanical disintegrator (8), preferably rotor (8), is arranged in the area of the open end (4″) of the dip tube (4′).

20. The device according to claim 19, characterized in that a lance (39) immersed in the metal bath (3) for ejecting a gas flow is guided inside the dip tube (4′) and that preferably guide vanes (40) for directing a gas flow are arranged in the metal bath (3) in the area of the mouth of the lance (39).

21. The device according to claim 19, characterized in that a lance (39′) is directed from the metal bath (3) towards the open end (4″) of the dip tube (4′) immersed in the metal bath (3) for ejecting a gas stream and that preferably guide vanes (40′) for directing a gas flow are arranged in the metal bath (3) in the area of the mouth of the lance (39′).

22. The device according to claim 19, 20 or 21, characterized in that the dip tube (4′) is connected to a discharge opening of a storage tundish (4) which receives the molten material (5) and that a weir tube (6) for forming an optionally interrupted annular space (6′) is immersed in the molten material (5).

23. The device according to claim 22, characterized in that a reactive metal bath (51), preferably reactive tin bath (51), is kept in the storage tundish (4), wherein the reactive metal bath (51) comprises reactive components selected from the group consisting of lime carriers and SiO₂ carriers for adjusting the basicity (CaO/SiO₂) of the molten material (5) to a target basicity of 0.85 to 1.6, preferably 1.3 to 1.6.

24. The device according to claim 23, characterized in that the reactive metal bath (51) contains Al₂O₃ carriers for setting an Al₂O₃ content in the molten material of 4 wt.-% to 18 wt.-%.

25. The device according to any one of claims 19 to 24, characterized in that the mechanical disintegrator (8) is formed by a plurality of actuators (29) which can be driven to rotate and by stators (30) emerging from the wall (2′) of the granulating tundish (2).

26 The device according to claim 25, characterized in that the stators (30) and/or the actuators (29) are designed to emit inert gas, preferably nitrogen, into the metal bath (3).

27. The device according to any one of claims 19 to 26, characterized in that the gas space (23) of the granulating tundish (2) is connected to a line for inert gas.

28. The device according to any one of claims 19 to 27, characterized in that a heat exchanger (18) is arranged as a cooling body in or on the wall (2′) of the granulating tundish (2).

29. The device according to any one of claims 19 to 28, characterized in that a heat exchanger (18) is arranged as a cooling body in the granulating tundish (2) in the volume for the metal bath (3).

30. The device according to any one of claims 19 to 29, characterized in that a discharge device in the form of a conveyor wheel (12) is arranged in the discharge region (14).

31. The device according to any one of claims 19 to 29, characterized in that a discharge device (41) in the form of a plurality of conveyor belts (43), for example made of steel belt, guided over pulleys (42) and arranged downstream of one another, is arranged in the discharge region (14), wherein the conveyor belts (43) are conducted out of the metal bath (3) in an ascending way, preferably at an angle of 30° to 50°, particularly preferably 40°, relative to the surface of the metal bath (3), wherein in each case a discharge (44) for the amorphous material (11) and/or for metal carried along from the metal bath (3) is formed at an upper pulley (42) and wherein in each case a discharge (44) of a conveyor belt (43) is arranged above a downstream conveyor belt (43) for forming a cascade of conveyor belts (43).

32. The device according to claim 31, characterized in that a further pulley (45) is each held, preferably resiliently held, against the conveyor belt (43) in the area of the upper pulley (42).

33. The device according to claim 31 or 32, characterized in that the discharge (44) of the last of the successive conveyor belts (43) is arranged above an insertion opening (47) of a cooling device (48) for the amorphous material (11), wherein the cooling device (48) can preferably be flowed through by a coolant (49), preferably in countercurrent.
